(19) United States
(12) Patent Application Publication
(10) Pub. No.: US 2026/0288026 A1
(43) Pub. Date: Sep. 24, 2026

(54) DEVELOPER SET AND IMAGE FORMING APPARATUS

(71) Applicant: KYOCERA Document Solutions Inc., Osaka (JP)

(72) Inventors: Minoru WADA, Osaka (JP); Takeo MIZOBE, Osaka (JP); Toru TAKATSUNA, Osaka (JP)

(73) Assignee: KYOCERA Document Solutions Inc., Osaka (JP)

(21) Appl. No.: 19/569,815

(22) Filed: Mar. 17, 2026

(30) Foreign Application Priority Data
Mar. 24, 2025 (JP) 2025-048535

(51) Int. Cl. G03G 9/107; G03G 9/113; G03G 15/08

(52) U.S. Cl. CPC G03G 9/107; G03G 9/1136; G03G 15/0865; G03G 15/0877

(57) ABSTRACT

A developer set includes a first developer as a two-component developer stored in a developing device from beginning of use of the developing device, and a second developer as a two-component developer stored in a replenishment container connected to the developing device, so as to be replenished to the developing device after starting use of the developing device. When a saturation magnetization of the carrier in the first developer is Sc, a resistance of the carrier in the first developer is R, and a content of the carrier with respect to toner of the second developer in the replenishment container is Cc, then 28<Sc×log₁₀ R×Cc<120 is satisfied.

### INCORPORATION BY REFERENCE

This application is based upon and claims the benefit of priority from the corresponding Japanese Patent Application No. 2025-048535 filed Mar. 24, 2025, the entire contents of which are hereby incorporated by reference.

### BACKGROUND

The present disclosure relates to a developer set and an image forming apparatus.

An electrophotographic image forming apparatus is equipped with a developing device. The developing device uses a two-component developer stored therein to develop an electrostatic latent image.

For instance, conventionally, a replenishment container that stores replenishment developer is attached to a main body of the image forming apparatus. When the developer stored in the developing device is consumed, the replenishment developer is replenished to the developing device, and hence the replenished replenishment developer and the developer that is initially stored in the developing device are used for developing electrostatic latent images.

### SUMMARY

A developer set according to a first aspect of the present disclosure, which is used for developing an electrostatic latent image by a developing device, contains a first developer and a second developer. The first developer is a two-component developer stored in the developing device from beginning of use of the developing device. The second developer is a two-component developer stored in a replenishment container connected to the developing device, so as to be replenished to the developing device after starting use of the developing device. When a saturation magnetization of a carrier in the first developer is Sc, a resistance of the carrier in the first developer is R, and a content of the carrier with respect to toner of the second developer in the replenishment container is Cc, then 28<Sc×log₁₀ R×Cc<120 is satisfied.

An image forming apparatus according to a second aspect of the present disclosure includes a developing device, a transfer unit, and a replenishment unit. The developing device uses the developer set described above, so as to develop an electrostatic latent image. The transfer unit transfers an image developed by the developing device onto a sheet. The developing device stores the first developer from beginning of use of the developing device. The replenishment unit replenishes the second developer from the replenishment container to the developing device after starting use of the developing device.

### BRIEF DESCRIPTION OF THE DRAWINGS

FIG. 1 is a schematic diagram of an image forming apparatus according to an embodiment.

FIG. 2 is a schematic diagram of a developing device and its vicinity according to the embodiment.

FIG. 3 is a schematic diagram of a developer set according to the embodiment.

FIG. 4 is a schematic diagram for explaining a measurement method of a carrier resistance of the developer set according to the embodiment.

FIG. 5 is a diagram illustrating a result of an experiment for checking effects of the embodiment.

### DETAILED DESCRIPTION

### <1. Image Forming Apparatus>

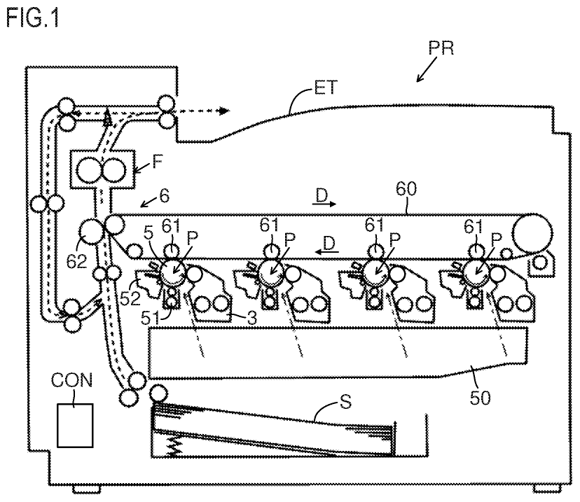

Hereinafter, with reference to FIG. 1, an image forming apparatus PR of this embodiment is described. The image forming apparatus PR is a printer.

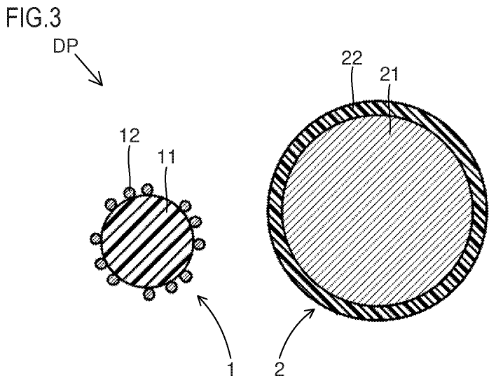

The image forming apparatus PR uses a developer set DP (see FIG. 3), so as to perform electrophotographic printing on a sheet S as a recording medium. As described later in detail, the developer set DP is a set of a first developer DP1 and a second developer DP2. The first developer DP1 and the second developer DP2 are each a two-component developer, and each include toner (an aggregate of toner particles 1) and carrier (an aggregate of carrier particles 2).

The image forming apparatus PR has a conveying path. In FIG. 1, the conveying path is shown by a broken line arrow. The image forming apparatus PR supplies the sheet S stored in a cassette to the conveying path, and conveys the sheet S along the conveying path. In this way, the sheet S passes through a transfer position and a fixing position in this order, and then is discharged onto a discharge tray ET. At the transfer position, a transferring process is performed on the sheet S. At the fixing position, a fixing process is performed on the sheet S.

The image forming apparatus PR includes four image forming units P corresponding to four colors, i.e., cyan, magenta, yellow, and black colors. Each of the image forming units P forms an image using toner of the corresponding color. Hereinafter, one of the image forming units P is noted and a structure thereof is described. The image forming units P have the same basic structure. Therefore, descriptions of structures of other image forming units P are omitted by citing the following description.

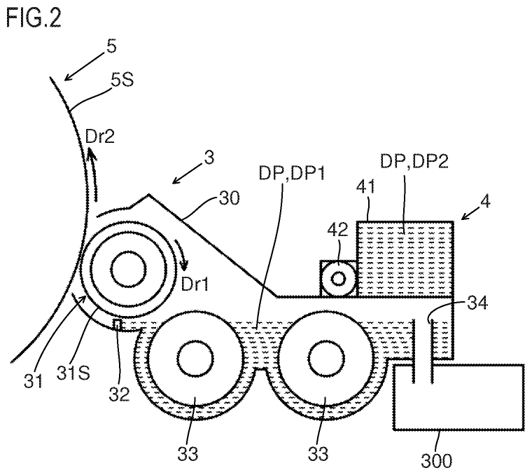

The image forming unit P includes developing device 3. The developing device 3 is connected to a replenishment unit 4 (see FIG. 2). In addition, the image forming unit P includes photosensitive drum 5. The photosensitive drum 5 constitutes one unit together with a charging device 51 and a cleaning device 52. Note that the image forming unit P includes an exposure device 50. The single exposure device 50 is shared by the image forming units P.

When the image forming unit P forms an image, the photosensitive drum 5 rotates. The charging device 51 charges the outer peripheral surface of the photosensitive drum 5. The exposure device 50 exposes the outer peripheral surface of the photosensitive drum 5, so as to form an electrostatic latent image on the outer peripheral surface of the photosensitive drum 5. The developing device 3 supplies toner to the electrostatic latent image on the outer peripheral surface of the photosensitive drum 5, so as to develop the electrostatic latent image into a toner image. The replenishment unit 4 replenishes the developer to the developing device 3. The cleaning device 52 removes residual toner on the outer peripheral surface of the photosensitive drum 5.

The image forming apparatus PR includes a transfer unit 6. The transfer unit 6 transfers the toner image on the outer peripheral surface of each photosensitive drum 5 to the sheet S. In other words, the transfer unit 6 transfers the images developed by the developing devices 3 to the sheet S.

The transfer unit 6 includes an intermediate transfer belt 60. The intermediate transfer belt 60 is an endless belt. The intermediate transfer belt 60 contacts the outer peripheral surfaces of the photosensitive drums 5, and in this state, moves (rotates) in the direction shown by an arrow D.

The transfer unit 6 includes primary transfer rollers 61. There are a plurality of the primary transfer rollers 61 each of which is allotted to each of the cyan, magenta, yellow, and black colors. The primary transfer rollers 61 are disposed on an inner peripheral side of the intermediate transfer belt 60. Each of the primary transfer rollers 61 is disposed to face the photosensitive drum 5 carrying the toner image of the corresponding color, via the intermediate transfer belt 60 between them.

In addition, the image forming apparatus PR includes one secondary transfer roller 62. The secondary transfer roller 62 is pressed to contact the outer peripheral surface of the intermediate transfer belt 60 at the transfer position. A transfer nip is formed between the secondary transfer roller 62 and the intermediate transfer belt 60. In other words, the transfer nip is formed at the transfer position.

In a print job, the sheet S is conveyed to the transfer position (i.e., the transfer nip). The sheet S that is being conveyed passes through the transfer nip.

The intermediate transfer belt 60 receives primary transfer of toner images from the photosensitive drums 5. The intermediate transfer belt 60 rotates while carrying the toner images on the outer peripheral surface. When the sheet S is passing through the transfer nip, the sheet S contacts the outer peripheral surface of the intermediate transfer belt 60. In this way, the toner images are secondarily transferred to the sheet S that is passing through the transfer nip.

The image forming apparatus PR includes a fixing unit F. The fixing unit F includes a heating roller and a pressure roller. The heating roller includes a heater inside. The pressure roller is pressed to contact the heating roller. The heating roller and the pressure roller contact each other with pressure so as to form a fixing nip at the fixing position.

In the print job, the sheet S after the transferring process passes through the fixing nip. In other words, the sheet S is sandwiched between the heating roller and the pressure roller at the fixing nip. The fixing unit F heats the sheet S that is passing through the fixing nip. At the fixing nip, the sheet S is pressed. The fixing unit F heats and presses the sheet S after the transferring process, so as to fix the toner image to the sheet S. After the fixing process, the sheet S is discharged onto the discharge tray ET.

### <2. Developing Device>

Hereinafter, with reference to FIG. 2, the developing device 3 of this embodiment is described.

The developing device 3 uses the developer set DP (see FIG. 3) so as to develop the electrostatic latent image. A development method of the developing device 3 is a trickle development method. The developing device 3 receives replenishment of the developer from the replenishment unit 4. In other words, the image forming apparatus PR includes the replenishment units 4 in addition to the developing devices 3. The replenishment unit 4 may be one component of the developing device 3.

The developing device 3 includes a development casing 30. The developer of the developer set DP is stored in the development casing 30. Only the first developer DP1 is stored in the development casing 30 in one case, or the first developer DP1 and the second developer DP2 are mixed and stored in the development casing 30 in another case. The developing device 3 uses the developer stored in the development casing 30 so as to perform development. Note that, for convenience's sake, FIG. 2 shows a state where only the first developer DP1 is stored in the development casing 30. In the following description, the developer stored in the development casing 30 is referred to as “developer currently in use”.

The developing device 3 includes a developing roller 31. The developing roller 31 is disposed inside the development casing 30 and is supported in a rotatable manner. The outer peripheral surface 31S of the developing roller 31 is partially exposed from inside to outside of the development casing 30. Specifically, the development casing 30 has an opening at a position facing an outer peripheral surface 5S of the photosensitive drum 5. From this opening, the outer peripheral surface 31S of the developing roller 31 is partially exposed to the outside. In this way, the outer peripheral surface 31S of the developing roller 31 and the outer peripheral surface 5S of the photosensitive drum 5 face each other.

The developing roller 31 carries the developer currently in use on the outer peripheral surface 31S, and supplies toner in the developer currently in use to the electrostatic latent image on the outer peripheral surface 5S of the photosensitive drum 5. In this case, the developing roller 31 and the photosensitive drum 5 rotate individually. In FIG. 2, a rotation direction of the developing roller 31 is shown by an arrow Dr1, and a rotation direction of the photosensitive drum 5 is shown by an arrow Dr2.

The developing roller 31 includes a sleeve and a magnet roller. The sleeve is supported in a rotatable manner. An outer peripheral surface of the sleeve carries the developer currently in use. The magnet roller is disposed inside the sleeve (inside the cylinder thereof). The magnet roller is supported in a manner unable to rotate. The magnet roller has a plurality of magnetic poles in the circumferential direction. The sleeve can rotate about an axis of the magnet roller.

The developing device 3 includes a regulating blade 32. The regulating blade 32 is attached to the development casing 30. The regulating blade 32 is disposed so that its distal end part is adjacent to the outer peripheral surface 31S of the developing roller 31. A distal end part of the regulating blade 32 is disposed on an upstream side of the facing area between the developing roller 31 and the photosensitive drum 5, in the rotation direction of the developing roller 31.

The developing device 3 includes two stirring screws 33. Each of the stirring screws 33 is disposed inside the development casing 30 and is supported in a rotatable manner. Each of the stirring screws 33 has a structure in which a helical blade is disposed on the rotation shaft. Each of the stirring screws 33 rotates so as to stir and convey the developer currently in use, while the toner in the developer currently in use is charged.

During rotation of the developing roller 31, the developer currently in use (specifically, the carrier carrying the toner) is attracted to the outer peripheral surface 31S of the developing roller 31 by a magnetic force of the magnet roller, and a magnetic brush is formed on the outer peripheral surface 31S of the developing roller 31. Further, when the magnetic brush passes through between the developing roller 31 and the regulating blade 32, the magnetic brush is regulated to have a constant layer thickness.

In addition, a development voltage is applied to the developing roller 31. In this way, a potential difference is generated between the developing roller 31 and the photosensitive drum 5. This potential difference allows the toner in the magnetic brush to move from the developing roller 31 to the photosensitive drum 5. In other words, the toner moves to the electrostatic latent image on the outer peripheral surface 5S of the photosensitive drum 5 (a part whose potential is decreased by exposure). As a result, the electrostatic latent image on the outer peripheral surface 5S of the photosensitive drum 5 is developed into the toner image.

The developing device 3 has a discharge path 34. The discharge path 34 connects the inside of the development casing 30 and a collection box 300. In this way, excess developer currently in use flows into the discharge path 34, moves along the discharge path 34, and reaches the collection box 300. In other words, the collection box 300 stores the excess developer currently in use.

The replenishment unit 4 includes a container 41 and a replenishment member 42. The container 41 corresponds to a “replenishment container”. The container 41 stores replenishment developer. The replenishment member 42 replenishes the replenishment developer stored in the container 41 to the developing device 3. For instance, the replenishment member 42 includes a screw shaft. When the screw shaft rotates, the replenishment developer is replenished from the container 41 to the inside of the development casing 30.

Here, the first developer DP1 is not the replenishment developer but the initial developer, which is stored in the developing device 3 (specifically, inside the development casing 30) from beginning of use of the developing device 3. On the other hand, the second developer DP2 is the replenishment developer. For this reason, when starting to use the developing device 3, in the development casing 30, only the first developer DP1 exists while the second developer DP2 does not exist (the state illustrated in FIG. 2). When starting to use the developing device 3, the second developer DP2 is stored in the container 41.

Note that the image forming apparatus PR includes a controller unit CON (see FIG. 1). The developing device 3 is equipped with a T/C sensor. The T/C sensor is connected to the controller unit CON. The T/C sensor detects a mixing ratio between the toner and the carrier in the developer currently in use. On the basis of an output of the T/C sensor, the controller unit CON controls replenishment of the replenishment developer from the replenishment unit 4 to the developing device 3. In other words, the controller unit CON controls the replenishment member 42 (to rotate and stop the screw shaft).

The T/C sensor is a magnetic permeability sensor and outputs a value corresponding to a magnetic permeability of the developer currently in use. As the ratio of the carrier in the developer currently in use is higher, the magnetic permeability of the developer currently in use is higher. Utilizing this fact, the mixing ratio between the toner and the carrier in the developer currently in use is detected. Further, a toner remaining amount in the developer currently in use can be detected from the detected mixing ratio.

When starting to use the developing device 3, the development casing 30 already stores initial developer inside. The initial developer is developer stored in the development casing 30 when the image forming apparatus PR is shipped (before a user uses the image forming apparatus PR). In other words, when starting to use the developing device 3, the developer currently in use contains only the initial developer.

After starting use of the developing device 3, when the print job is performed, the developer currently in use is consumed and decreased. In other words, the initial developer is decreased inside the development casing 30. For this reason, after starting use of the developing device 3, the replenishment developer is replenished from the replenishment unit 4 to the developing device 3.

While the image forming apparatus PR continues the print job, the replenishment developer is replenished into the development casing 30 while the developer currently in use is discharged from the inside of the development casing 30. In this way, inside the development casing 30, the developer currently in use is gradually changed, i.e., the initial developer is gradually replaced by the replenishment developer. In other words, the initial developer and the replenishment developer are mixed as the developer currently in use.

### <3. Developer Set>

Hereinafter, with reference to FIG. 3, the developer set DP of this embodiment is described.

The developer set DP contains the first developer DP1 and the second developer DP2. In other words, the developer set DP contains the initial developer (corresponding to the first developer DP1) and the replenishment developer (corresponding to the second developer DP2). The first developer DP1 and the second developer DP2 are stored in the developing device 3 and are used for developing the electrostatic latent image by the developing device 3.

The first developer DP1 and the second developer DP2 are each a two-component developer. The two-component developer contains the toner and the carrier.

For instance, the first developer DP1 and the second developer DP2 have the same toner. However, this is not a limitation. At least a part of the component, the production method, and the like of the toner may be different between the first developer DP1 and the second developer DP2.

In addition, the first developer DP1 and the second developer DP2 have the same carrier. However, this is not a limitation. At least a part of the component, the production method, and the like of the carrier may be different between the first developer DP1 and the second developer DP2.

Here, the content of the carrier with respect to the toner is different between the first developer DP1 and the second developer DP2. Specifically, the content of the carrier with respect to the toner of the initial developer, which is stored inside the development casing 30 from beginning of use of the developing device 3, is different from the content of the carrier with respect to the toner of the replenishment developer, which is stored in a new container 41.

Each toner of the first developer DP1 and the second developer DP2 contains the toner particles 1, and each carrier of the first developer DP1 and the second developer DP2 contains the carrier particles 2. The aggregate of the toner particles 1 is the toner, and the aggregate of the carrier particles 2 is the carrier. FIG. 3 schematically illustrates the single toner particle 1 and the single carrier particle 2.

### <3-1. Toner>

The toner particle 1 has a toner mother particle 11. The toner mother particle 11 is, for example, a non-encapsulated toner mother particle without a shell layer. The toner mother particle 11 may be an encapsulated toner mother particle in which a toner core is coated with a shell layer.

The toner mother particle 11 contains binder resin, for example. As the binder resin, a thermoplastic resin such as polyester resin may be used. The toner mother particle 11 may contain a coloring agent, a charge control agent, a mold release agent, and the like.

The toner particle 1 has external additive particles 12. The external additive particles 12 adhere to the surface of the toner mother particle 11. As the external additive particles 12, silica particles, aluminum oxide particles, or the like may be used. In addition, if necessary, resin particles, magnesium oxide particles, zinc oxide particles, or the like may be used as the external additive particles 12.

In the toner particle 1, the contained amount of the silica particles is preferably 0.1 pts. mass or more and 10.0 pts. mass or less, and more preferably 0.4 pts. mass or more and 3.0 pts. mass or less, with respect to 100.0 pts. mass of toner mother particle 11. In addition, the mean primary particle diameter of the silica particle is preferably 10 nm or more and 30 nm or less, and more preferably 15 nm or more and 25 nm or less. The silica particle may be surface treated.

The contained amount of the aluminum oxide particles in the toner particle 1 is preferably 0.05 pts. mass or more and 3.0 pts. mass or less, and more preferably 0.3 pts. mass or more and 1.5 pts. mass or less, with respect to 100.0 pts. mass of toner mother particle 11. In addition, the mean primary particle diameter of the aluminum oxide particle is preferably 200 nm or more and 600 nm or less, and more preferably 300 nm or more and 500 nm or less.

Note that the mean primary particle diameter in this specification is a mean value of equivalent circle diameters of primary particles measured using a scanning electron microscope (a Heywood diameter: a diameter of a circle having the same area as a projected area of the primary particle). The mean primary particle diameter is, for example, a mean value of equivalent circle diameters of 100 primary particles. For measuring the mean primary particle diameter, a field emission type scanning electron microscope (“JSM-7600F” manufactured by Japan Electron Optics Laboratory Co., Ltd.) can be used.

### <3-2. Carrier>

The carrier particle 2 has a carrier core 21. The carrier core 21 contains magnetic material. As the magnetic material, it is possible to use a metal oxide such as ferrite, magnetite, or maghemite. Note that the ferrite has high flowability and chemical stability tendency. For this reason, it is preferred that the carrier core 21 contain ferrite. As an example of the ferrite, there is Ba ferrite, Mn ferrite, Mn—Zn ferrite, Ni—Zn ferrite, Mn—Mg ferrite, Ca—Mg ferrite, Li ferrite, and Cu—Zn ferrite. The shape of the carrier core 21 is not particularly limited, and it may be an irregular shape or a spherical shape.

The carrier core 21 has a saturation magnetization of 65 emu/g or more and 90 emu/g or less. Note that in this specification, the saturation magnetization is a value measured using a sensitive vibrating sample magnetometer (“VSM-P7” manufactured by Toei Industry Co., Ltd.) under the condition of an external magnetic field of 3,000 (Oe). If the carrier core 21 contains Mn ferrite, there is a tendency that as the content of Mn is higher, the saturation magnetization of the carrier core 21 is lower. If the carrier core 21 contains Mn—Mg ferrite, there is a tendency that as the content of Mg is higher, the saturation magnetization of the carrier core 21 is lower.

Here, if the developer currently in use stored in the developing device 3 has a low saturation magnetization of the carrier, carrier development occurs in which the carrier adheres to the photosensitive drum 5, and image quality is lowered. For this reason, it is preferred that the carrier (i.e., the carrier core 21) in the developer currently in use have a saturation magnetization of 65 emu/g or more and 90 emu/g or less.

The carrier particle 2 has a coat layer 22. The coat layer 22 coats the surface of the carrier core 21. For instance, the entire surface of the carrier core 21 is coated by the coat layer 22. The coat layer 22 is made of silicone resin. In other words, the coat layer 22 contains silicone resin as a main component (a main component of the coat layer 22 in mass base is silicone resin). The constituent resin of the coat layer 22 may consist essentially of silicone resin, or in another embodiment, may contain other resins in addition to the silicone resin. In addition, the constituent material of the coat layer 22 may contain a fluorocarbon resin.

As a preferred example of the silicone resin, there is silicone resin having a methyl group, and epoxy modified silicone resin. An example of the silicone resin having a methyl group is a silicone resin that has a methyl group but does not have a phenyl group. Another example of the silicone resin having a methyl group is a silicone resin that has a methyl group and a phenyl group.

The coat layer 22 contains barium titanate particle. The contained amount of the barium titanate particles in the coat layer 22 is 2 pts. mass or more and 47 pts. mass or less, and preferably 3 pts. mass or more and 35 pts. mass or less, and more preferably 10 pts. mass or more and 25 pts. mass or less, with respect to 100 pts. mass of the silicone resin. The mean primary particle diameter of the barium titanate particle is 100 nm or more and 500 nm or less, and preferably 150 nm or more and 450 nm or less, and more preferably 250 nm or more and 350 nm or less.

In addition, the coat layer 22 contains carbon black particles. The contained amount of the carbon black particles is 4 pts. mass or less with respect to 100 pts. mass of the silicone resin. The mean primary particle diameter of the carbon black particle is 10 nm or more and 80 nm or less, and preferably 30 nm or more and 45 nm or less.

Because the coat layer 22 contains the carbon black particles, charges move smoothly from the carrier particles 2 to the toner particles 1, and hence the toner particles 1 can be charged to a desired charge amount. In this way, an image having a desired image density and little fogging can be formed.

### <4. Carrier Content of Replenishment Developer>

Hereinafter, the content of the carrier with respect to the toner of the second developer DP2 stored in the container 41 (i.e., carrier content of the replenishment developer) is described. The content is a ratio of the carrier when the toner is 1.

In this embodiment, the content of the carrier with respect to the toner of the second developer DP2 stored in the container 41 is controlled so as to satisfy the following inequality (1).

$$28 < S c \times {log}_{10} R \times C c < 120 \qquad ( 1 )$$

In the above inequality (1), the content of the carrier with respect to the toner of the second developer DP2 stored in the container 41 is Cc. In the above inequality (1), Sc is the saturation magnetization (emu/g) of the carrier of the first developer DP1. R in the above inequality (1) is a resistance of the carrier of the first developer DP1. Note that the carriers of the first developer DP1 and the second developer DP2 have the same saturation magnetization. In addition, the carriers of the first developer DP1 and the second developer DP2 have the same resistance.

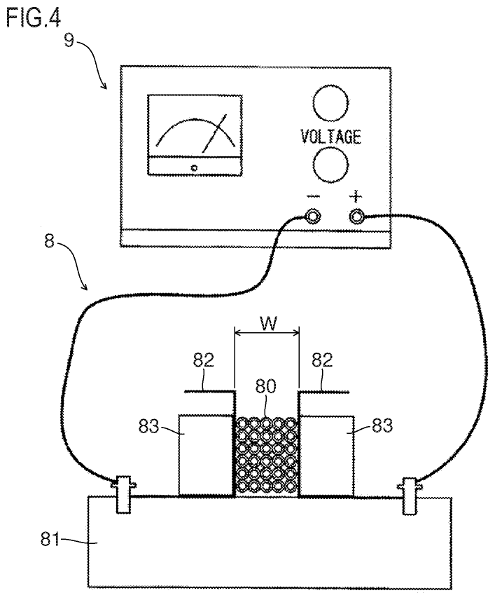

Here, in this embodiment, a resistance determined on the basis of a measurement result by a bridge method is a carrier resistance (R in the above inequality (1)). Specifically, in measurement of the carrier resistance, as illustrated in FIG. 4, a bridge type resistance measuring device 8 and a super megohmmeter 9 (“SM-8220” manufactured by HIOKI E.E. Corporation) are used. The bridge type resistance measuring device 8 has a pair of electrode plates 82 fixed on a top surface of a substrate 81 made of acrylic resin. The pair of electrode plates 82 are disposed to face each other with a space W of 1 mm. Surfaces of the pair of electrode plates 82 face each other. A magnet 83 of 1,000 gauss is disposed on each back side of the pair of electrode plates 82. The facing side of each magnet 83 has an area of 3 cm². In this way, a magnetic field is formed between the pair of electrode plates 82.

A carrier sample 80 is set between the pair of electrode plates 82. The amount of the set carrier sample 80 is 0.2 g. The carrier sample 80 is filled between the pair of electrode plates 82, so as to have a chain structure along magnetic field lines. In this state, a DC voltage of 1,000 V (an electric field of 1×10⁶ V/m) is applied between the terminals, and ten seconds later the resistance value is read by the super megohmmeter 9, and the read value (unit: ohms) is the carrier resistance (R in the above inequality (1)).

In this embodiment, it is managed so that the content of the carrier with respect to the toner of the second developer DP2 stored in the container 41 satisfies the above inequality (1). In other words, it is managed so that the content of the carrier with respect to the toner of the replenishment developer stored in the container 41 satisfies the above inequality (1). Hereinafter, the content is simply referred to as a “replenishment carrier content”.

By controlling the replenishment carrier content so as to satisfy the above inequality (1), the mixing ratio between the toner and the carrier of the developer (i.e., the developer currently in use) in the developing device 3 can be accurately detected. In this way, the remaining amount of the developer currently in use can be stabilized. As a result, it is possible to suppress a decrease in stability of the image density, for a long period.

In addition, by controlling the replenishment carrier content so as to satisfy the above inequality (1), it is possible to suppress an increase of the carrier whose characteristics are changed (such as the carrier to which the toner's external additives are adhered). In this way, deterioration of toner chargeability due to the characteristic change of the carrier can be suppressed. As a result, occurrence of fogging in which the toner is adhered to a non-image area of the photosensitive drum 5 (in other words, fogging in which the toner is adhered to a blank area of the sheet S) can be suppressed, for a long period.

In other words, in this embodiment, it is possible to suppress deterioration of the image quality, for a long period from beginning of use of the developing device 3.

Note that in this embodiment, because the coat layer 22 is made of silicone resin, it is possible to obtain the carrier having high durability. In addition, from the viewpoint of PFAS regulations in recent years, it is preferred to use silicone resin as the constituent material of the coat layer 22.

### <5. Confirmation Experiment>

Hereinafter, an experiment is described, which was performed for checking effects of this embodiment.

In the confirmation experiment, the developer set (the initial developer and the replenishment developer) was produced and used for printing, and states of printed images were checked. As the evaluation machine, an image forming apparatus (Taskalfa3554ci) manufactured by KYOCERA Document Solutions Inc. was used. In addition, the number of the printed sheets was 100,000.

### <5-1. Preparation of Toner>

The toner to be used for the confirmation experiment was prepared by the following method.

### <5-1-1. Synthesis of Amorphous Polyester Resin>

A reaction container, equipped with a thermometer (thermocouple), a dewatering conduit, a nitrogen gas introduction conduit, and a stirring device (stirring blade), was set to an oil bath. Then, 1,575 g of bisphenol A propylene oxide additive (BPA-PO), 163 g of bisphenol A ethylene oxide additive (BPA-EO), 377 g of fumaric acid, and 4 g of catalyst (dibutyltin oxide) were put into the reaction container.

After creating a nitrogen atmosphere in the reaction container, the temperature inside the reaction container was raised to 220 degrees Celsius while stirring the contents. Under the conditions of the nitrogen atmosphere and the temperature of 220 degrees Celsius, polymerization reaction of the contents in the reaction container was performed for 8 hours while removing by-product water. Next, the pressure inside the reaction container is reduced, and under the conditions of the reduced pressure atmosphere (pressure: 7,999 Pa) and the temperature of 220 degrees Celsius, the polymerization reaction of the contents in the reaction container was performed for more 1 hour. In addition, the temperature inside the reaction container was reduced to 210 degrees Celsius, and then 336 g of trimellitic anhydride was added into the reaction container. Then, under the conditions of the reduced pressure atmosphere (pressure: 7,999 Pa) and the temperature of 210 degrees Celsius, reaction of the contents in the reaction container was performed. After that, the reaction product was taken out from the reaction container and was cooled, and hence the amorphous polyester resin having the following physical properties was obtained. Note that the polyester resin obtained in this way did not clearly show its endothermic peak in the endothermic curve measured using a differential scanning calorimeter, and its clear melting point was not able to be measured, and thus it was determined to be amorphous.
softening point (Tm): 100 degrees Celsius
glass transition point (Tg): 50 degrees Celsius
mass average molecular weight (Mw): 30,000
acid value: 15 mgKOH/g
hydroxyl value: 30 mgKOH/g

### <5-1-2. Preparation of Toner Mother Particles>

Using an FM mixer (“FM-10B” manufactured by Nippon Coke & Engineering Co., Ltd.), 100 pts. mass of binder resin, 4 pts. mass of coloring agent, 1 pts. mass of charge control agent, and 5 pts. mass of mold release agent were mixed, so that the mixture was obtained. As the binder resin, the amorphous polyester resin described above was used. As the coloring agent, copper phthalocyanine blue pigment (C.I. Pigment Blue 15:3) was used. As the charge control agent, quaternary ammonium salt (“BONTRON (registered trademark) P-51” manufactured by Orient Chemical Industries Co., Ltd.) was used. As the mold release agent, carnauba wax (“Special Carnauba Wax 1st” manufactured by S. KATO & CO.) was used.

Next, using a twin-screw extruder (“PCM-30 type” manufactured by Ikegai Co., Ltd.), the mixture was melted and kneaded, so that the melted and kneaded material was obtained. In addition, using a mechanical pulverizer (“Turbo Mill” manufactured by Freund-Turbo Corporation), the melted and kneaded material was pulverized, so that the pulverized material was obtained. Then, using a classifier (“Elbow Jet” manufactured by Nittetsu Mining Co., Ltd.), the pulverized material was classified. In this way, powder-like toner mother particles having a volume median diameter of 6.8 m were obtained. Note that the volume median diameter (Dso) is a median diameter measured using a laser diffraction/scattering type particle size distribution measurement device (“LA-950” manufactured by HORIBA, Ltd.).

### <5-1-3. External Addition to Toner Mother Particles>

Using the FM mixer (“FM-10B” manufactured by Nippon Coke & Engineering Co., Ltd.), 100.0 pts. mass of the toner mother particle described above, 1.0 pts. mass of the silica particles (mean primary particle diameter: 20 nm), and 0.75 pts. mass of aluminum oxide particles (“AEROXIDE (registered trademark) Alu C805” manufactured by Nippon Aerosil Co., Ltd., BET specific surface area: 75 to 105 m²/g) were mixed for 5 minutes under the condition of 4,000 rpm, so that the mixture was obtained. Note that the mean primary particle diameter of the aluminum oxide particles is more than 300 nm. Then, using a sieve of 200 mesh (aperture of 75 m), the mixture was sieved, and the toner shown in Table 1 was obtained. In the following description, the toner is shown by “T”.

TABLE 1
toner (T)

| mother | external additive particle | |
|---|---|---|
| particle | alumina particle | silica particle |

| pts. mass | pts. mass | pts. mass | diameter (nm) |
|---|---|---|---|
| 100 | 0.75 | 1 | 20 |

### <5-2. Preparation of Carrier>

The carrier to be used for the confirmation experiment was prepared by the following method.

### <5-2-1. Preparation of Coating Liquid>

Coat resin solution, the barium titanate particles, the carbon black particles, and toluene were put into a stainless steel container. Then, using a homogenizer, the contents in the stainless steel container were mixed, so that the coating liquid was obtained. As the barium titanate particle, “BT-01” manufactured by Sakai Chemical Industry Co., Ltd. (mean primary particle diameter: 304 nm) was used. As the carbon black particle, “Ketjenblack (registered trademark) EC300J” manufactured by LION SPECIALTY CHEMICALS CO., Ltd. (mean primary particle diameter: 39.5 nm), which is conductive carbon black, was used.

### <5-2-2. Preparation of Carrier Particles>

Using a fluid bed coating machine (“FD-MP-01 D type” manufactured by Powrex Corporation), 5,000 g of the carrier cores were allowed to flow, while the coating liquid was sprayed to the carrier cores. In this way, the carrier cores coated with the coating liquid were obtained. In this case, as the carrier cores, manganese ferrite cores (manufactured by DOWA IP Creation Co., Ltd., volume median diameter: 40 μm) were used. In addition, the amount of the coating liquid input to the fluid bed coating machine was adjusted, so that the mass of the coat layer (the layer obtained by heating the coating liquid) became 15 g with respect to 1,000 g of the carrier core. Next, using an electric furnace, the carrier cores coated with the coating liquid were fired for 1 hour, so that the coat layer was formed on the surface of the carrier core. In this way, the carrier particles were obtained.

Here, in the confirmation experiment, the carriers C1 to C5 were used. Characteristics of the carriers C1 to C5 are shown in Table 2. Note that resistances of the carriers C1 to C5 shown in Table 2 are values obtained from the result of the measurement by the method illustrated in FIG. 4.

TABLE 2
carrier

| | Sc × | saturation magnetization | resistance R | |
|---|---|---|---|---|
| type | log₁₀R | Sc (emu/g) | (Ω) | coat resin |
| C1 | 1073 | 80 | 2.6 × 10¹³ | silicone |
| C2 | 952 | 70 | 4.0 × 10¹³ | FEP/PAI |
| C3 | 815 | 80 | 1.5 × 10¹⁰ | silicone |
| C4 | 790 | 70 | 1.9 × 10¹¹ | FEP/PI |
| C5 | 662 | 65 | 1.5 × 10¹⁰ | silicone |

As illustrated in Table 2, the saturation magnetizations of the carriers C1 and C3 are each 80 emu/g. The saturation magnetizations of the carriers C2 and C4 are each 70 emu/g. The saturation magnetization of the carrier C5 is 65 emu/g.

The carrier C1 has a resistance of 2.6×10¹³ ohms. In this way, In the carrier C1, the value of “Sc” in the above inequality (1) is 80, and the value of “R” is 2.6×10¹³, and hence the value of “Sc×log₁₀ R” in the above inequality (1) is 1073.

The carrier C2 has a resistance of 4.0×10¹³ ohms. In this way, in the carrier C2, the value of “Sc” in the above inequality (1) is 70, and the value of “R” is 4.0×10¹³, and hence the value of “Sc×log₁₀ R” in the above inequality (1) is 952.

The carrier C3 has a resistance of 1.5×10¹⁰ ohms. In this way, in the carrier C3, the value of “Sc” in the above inequality (1) is 80, the value of “R” is 1.5×10¹⁰, and hence the value of “Sc×log₁₀ R” in the above inequality (1) is 815.

The carrier C4 has a resistance of 1.9×10¹¹ ohms. In this way, in the carrier C4, the value of “Sc” in the above inequality (1) is 70, the value of “R” is 1.9×10¹¹, and hence the value of “Sc×log₁₀ R” in the above inequality (1) is 790.

The carrier C5 has a resistance of 1.5×10¹⁰ ohms. In this way, in the carrier C5, the value of “Sc” in the above inequality (1) is 65, the value of “R” is 1.5×10¹⁰, and hence the value of “Sc×log₁₀ R” in the above inequality (1) is 662.

In addition, for the carrier C1, C3, and C5, the coat layer was made of a silicone resin. For the carrier C1, C3, and C5, as the silicone resin, “KR-255” (solid content: methylphenyl silicone resin, solid content concentration: 50 mass %) manufactured by Shin-Etsu Chemical Co., Ltd. was used. For the carrier C2, the coat layer was made of a fluorocarbon resin (FEP) and a polyamide resin (PAI). For the carrier C4, the coat layer was made of a fluorocarbon resin (FEP) and a polyimide resin (PI).

### <5-3. Preparation of Developer Set>

In the confirmation experiment, first to fifth developer sets were prepared. Note that the mass ratio of the toner with respect to the carrier in each initial developer of the first to the fifth developer sets is 6 mass % (T/C6%). The initial developer and the replenishment developer have different contents of the carrier.

The developer in which the toner T and the carrier C1 are mixed was prepared as each of the initial developer and the replenishment developer of the first developer set. In the first developer set, the value of “Sc×log₁₀ R” in the above inequality (1) is 1073.

The developer in which the toner T and the carrier C2 are mixed was prepared as each of the initial developer and the replenishment developer of the second developer set. In the second developer set, the value of “Sc×log₁₀ R” in the above inequality (1) is 952.

The developer in which the toner T and the carrier C3 are mixed was prepared as each of the initial developer and the replenishment developer of the third developer set. In the third developer set, the value of “Sc×log₁₀ R” in the above inequality (1) is 815.

The developer in which the toner T and the carrier C4 are mixed was prepared as each of the initial developer and the replenishment developer of the fourth developer set. In the fourth developer set, the value of “Sc×log₁₀ R” in the above inequality (1) is 790.

The developer in which the toner T and the carrier C5 are mixed was prepared as each of the initial developer and the replenishment developer of the fifth developer set. In the fifth developer set, the value of “Sc×log₁₀ R” in the above inequality (1) is 662.

### <5-4. Evaluation>

As a confirmation experiment, an experiment for confirming an upper limit of the replenishment carrier content (an upper limit confirmation experiment) was performed. In addition, as a confirmation experiment, an experiment for confirming a lower limit of the replenishment carrier content (a lower limit confirmation experiment) was performed.

In the upper limit confirmation experiment, for each of the first to the fifth developer sets, the replenishment carrier content was changed in 0.02 steps from 0.1 to 0.2, so as to print an image on a sheet in each condition, and the image density of each printed sheet (specifically, density of a solid patch image) was measured, using a reflection densitometer (“SpectroEye (registered trademark)” manufactured by X-Rite Incorporated). In addition, it was determined how much the image density has changed from printing of the first sheet to printing of the 100,000th sheet (here, referred to as an ID change). Then, the evaluation was performed by the following criteria.
OK (no problem): The ID change is ±0.3 or less.
NG (has a problem): The ID change is more than +0.3.

In the lower limit confirmation experiment, for each of the first to the fifth developer sets, the replenishment carrier content was changed in 0.01 steps from 0.01 to 0.05, so as to print an image on a sheet in each condition, and an image density (D) of a blank area of each printed sheet was measured, using a white color photometer (“TC-6DS” manufactured by Tokyo Denshoku Ltd.). In addition, a reflection density (D₀) of an unprinted sheet was measured, so as to determine a fogging density (=D−D₀). Then, the evaluation was performed by the following criteria. Note that in the lower limit confirmation experiment, the printing was performed at a temperature of 32 degrees Celsius and a humidity of 85% RH (under HH environment).
OK (no problem): The fogging density is 0.015 or less.
NG (has a problem): The fogging density is more than 0.015.

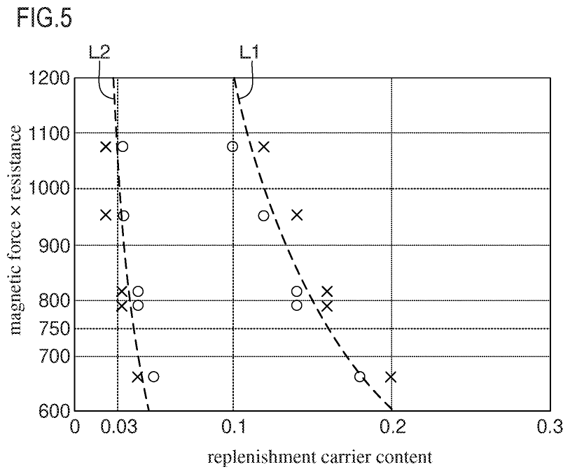

Results of the upper limit confirmation experiment and the lower limit confirmation experiment are illustrated in FIG. 5. Note that in FIG. 5, the vertical axis (magnetic force×resistance) corresponds to Sc×log₁₀ R″ in the above inequality (1)″. In FIG. 5, the horizontal axis (the replenishment carrier content) corresponds to “Cc” in the above inequality (1).

In the result of the upper limit confirmation experiment illustrated in FIG. 5, for each of the first to the fifth developer sets, the maximum replenishment carrier content in which the ID change is “OK” in the above range (0.1 to 0.2) is shown by a circle mark. On the other hand, the minimum replenishment carrier content in which the ID change is “NG” in the above range (0.1 to 0.2) is shown by an x mark.

In addition, in the result of the lower limit confirmation experiment illustrated in FIG. 5, for each of the first to the fifth developer sets, the minimum replenishment carrier content in which the fogging density is “OK” in the above range (0.01 to 0.05) is shown by a circle mark. On the other hand, the maximum replenishment carrier content in which the fogging density is “NG” in the above range (0.01 to 0.05) is shown by an x mark.

Further, in FIG. 5, the boundary between the maximum replenishment carrier content in which the ID change is “OK” and the minimum replenishment carrier content in which the ID change is “NG” is shown by a line L1. In addition, the boundary between the minimum replenishment carrier content in which the fogging density is “OK” and the maximum replenishment carrier content in which the fogging density is “NG” is shown by a line L2.

According to the result shown in FIG. 5, it can be said that the line L1 in FIG. 5 is the upper limit of the replenishment carrier content. In addition, it can be said that the line L2 in FIG. 5 is the lower limit of the replenishment carrier content.

As an example, when using the carrier C1 (magnetic force×resistance=1073), if the replenishment carrier content is 0.1, the image density is stable, and the fogging is suppressed. In this example, the value of “Sc×log₁₀ R×Cc” in the above inequality (1) is 107.3 (=1073×0.1), and hence the above inequality (1) is satisfied.

In addition, when using the carrier C1 (magnetic force×resistance=1073), if the replenishment carrier content is 0.04, the image density is stable, and the fogging is suppressed. In this example, the value of “Sc×log₁₀ R×Cc” in the above inequality (1) is 42.92 (1073×0.04), and hence the above inequality (1) is satisfied.

As another example, when using the carrier C5 (magnetic force×resistance=662), if the replenishment carrier content is 0.18, the image density is stable, and the fogging is suppressed. In this example, the value of “Sc×log₁₀ R×Cc” in the above inequality (1) is 119.16 (=662×0.18), and hence the above inequality (1) is satisfied.

In addition, when using carrier C5 (magnetic force×resistance=662), if the replenishment carrier content is 0.05, the image density is stable, and the fogging is suppressed. In this example, the value of “Sc×log₁₀ R×Cc” in the above inequality (1) is 33.1 (=662×0.05), and hence the above inequality (1) is satisfied.

Therefore, it can be said that the image density can be stabilized and the fogging can be suppressed by controlling the replenishment carrier content so as to satisfy the above inequality (1).

Here, it is preferred that the replenishment carrier content be lower. When the replenishment carrier content is lower, the running cost can be reduced.

For instance, it is supposed that the center value between the upper limit line L1 and the lower limit line L2 illustrated in FIG. 5 is set as the replenishment carrier content. In this case, if “Sc×log₁₀ R (=magnetic force×resistance)” in the above inequality (1) is more than 750, the replenishment carrier content can be set to be 0.1 or less. In this way, it is preferred to satisfy the following inequality (2).

$$750 < S c \times {log}_{10} R < 1 , 200 \qquad ( 2 )$$

Further, if “Sc×log₁₀ R (=magnetic force×resistance)” in the above inequality (1) is more than 1,000, the replenishment carrier content can be set to be 0.07 or less. In this way, it is preferred to satisfy the following inequality (3).

$$1 , 000 < Sc \times {log}_{10} R < 1 , 200 \qquad ( 3 )$$

In addition, from the viewpoint of running cost, it can be said that it is preferred to control the replenishment carrier content (Cc) to satisfy the following inequality (4).

$$0.03 < Cc < 0.1 \qquad ( 4 )$$

The embodiment disclosed this time is merely an example in every aspect, and should not be considered as a limitation. The scope of the present disclosure is defined not by the above description of the embodiment but by the claims, and further it includes all modifications within meaning and scope equivalent to the claims.

What is claimed is:

1. A developer set to be used for developing an electrostatic latent image by a developing device, the developer set comprising:
a first developer as a two-component developer stored in the developing device from beginning of use of the developing device; and
a second developer as a two-component developer stored in a replenishment container connected to the developing device, so as to be replenished to the developing device after starting use of the developing device, wherein
when a saturation magnetization of a carrier in the first developer is Sc, a resistance of the carrier in the first developer is R, and a content of the carrier with respect to toner of the second developer in the replenishment container is Cc, then 28<Sc×log₁₀ R×Cc<120 is satisfied.

2. The developer set according to claim 1, wherein 750<Sc×log₁₀ R<1,200 is satisfied.

3. The developer set according to claim 2, wherein 1,000<Sc×log₁₀ R<1,200 is satisfied.

4. The developer set according to claim 1, wherein 0.03<Cc<0.1 is satisfied.

5. The developer set according to claim 1, wherein the first developer and the second developer have the same carrier.

6. The developer set according to claim 1, wherein
each carrier of the first developer and the second developer contains carrier cores coated by coat layers, and
the coat layer is made of silicone resin.

7. An image forming apparatus comprising:
a developing device configured to use the developer set according to claim 1, so as to develop an electrostatic latent image;
a transfer unit configured to transfer an image developed by the developing device onto a sheet; and
a replenishment unit, wherein
the developing device stores the first developer from beginning of use of the developing device, and
the replenishment unit replenishes the second developer from the replenishment container to the developing device after starting use of the developing device.
